(19) United States
(12) Patent Application Publication
(10) Pub. No.: US 2009/0145852 A1
(43) Pub. Date: Jun. 11, 2009

(54) HEATING SYSTEM AND METHOD FOR PREVENTION OF UNDERGROUND TANK FREEZE-UPS

(76) Inventor: Christopher T. Norgaard, Gully, MN (US)

Correspondence Address: Moore & Hansen, PLLP, Suite 4850, 225 South Sixth Street, Minneapolis, MN, 55402, US

(21) Appl. No.: 11/951,894

(22) Filed: Dec. 6, 2007

(51) Int. Cl. C02F 1/02

(52) U.S. Cl. 210/742; 210/149; 210/175; 210/532.2

(57) ABSTRACT

Heating systems and methods of preventing freeze-ups of underground tank systems. In septic underground tank systems, bacteria activity is enhanced by raising the temperature within the bacteria's environment. The preferred heater system includes a thermostatic control unit with a temperature sensor which may be selectively located to sense the temperature within a portion of the underground tank system. The heating systems and methods are particularly useful in mound or drainfield septic systems as well as underground water tanks.

### BACKGROUND OF THE DISCLOSURE

1. Field of the Invention

The present invention relates generally to heating systems. Particularly, the present invention relates to heating systems for the prevention of underground tank system freeze-ups and to enhance bacterial activity in septic system tanks. More particularly, the present invention relates to a heating system having a thermostatic control unit which may be selectively located to sense the temperature within a portion of an underground tank system containing a fluid subject to freeze-up.

2. Description of the Related Art

Previously, it was common to bury septic tanks deep in the ground. Due to current government regulations, septic tanks are now often installed very shallow. This is to help limit the amount of sewage that seeps into the water supply. In many areas, during cold winter months, frost penetrates several feet into the ground. This makes septic systems buried shallow in the ground very vulnerable to freezing, especially septic systems that are not used daily.

Freezing can occur anywhere within a septic system. Particularly, if there is a sag in the pipe, the sag is often the cause as the standing water freezes and then builds as water trickles past until the pipe is completely blocked. When a septic system freezes, the flow of effluent from the septic tank is obstructed, causing the septic system to back up and become inoperative. Additionally, freezing or near freezing septic tanks have significantly reduced bacterial activity. Decreased bacterial activity results in a slowing of the natural decomposition of organic solids in the tank.

Another common area of freeze-up is where the sewage enters the drainfield, at which point the pipe connects to a drop box. The drop box is usually less than 3 feet underground and always has water in it. This area will freeze when surrounded by frozen ground. When the drop box water freezes, ice builds up as water trickles from the septic tank, eventually blocking the pipe.

In traditional mound systems or systems with lift stations, which utilize a pump to force sewage under pressure into an elevated, earthen mound, freezing can occur between the house and the tank, within the tank or lift station itself, after the lift station, and/or in the mound. The most common area where freezing occurs is the lift station and the discharge pipe that leads from the lift station pump to the mound. If the pipe that goes to the mound freezes, it is often because the weep hole in the pipe has frozen shut, preventing the residual water from draining back into the lift station.

There are generally two known ways to remedy a frozen septic system, both of which are costly, time consuming and inconvenient. The first remedy is to have a plumber jet or steam the underground pipes, usually a few times during the cold spell. This is an effective way to unclog the pipes, but there are risks of overstressing the pipe and joints. The amount of pressure and heat used in this method can exceed 2000 psi and 500° F. Sewer pipe is typically not designed to sustain such extreme temperature. This remedy usually requires multiple service calls because the pipe eventually refreezes since nothing is done to prevent future freezing.

The second remedy is to have your tank pumped regularly while your pipes are clogged and allow the ground to thaw at its natural pace. This method is inconvenient, unpredictable and requires careful restricted use of water to minimize the risk of pipes backing up sewage into the home.

To address freeze-ups in septic systems, heated systems for the prevention of freeze-ups have been devised. One such system is taught in U.S. Pat. No. 6,869,533 (2005, Norgaard). This known system includes a heater, fan and thermostat in an enclosure located above ground that is interconnected with a cleanout pipe of a traditional drainfield system. The thermostat measures the outdoor temperature such that the heater will be activated when the outdoor temperature reaches a predetermined level in which the septic fluid would be likely to freeze. Hot air is then transferred from the heater to the respective cleanout pipe and circulated through the drop box and into a drainfield.

In some areas having particularly rocky soil making it difficult to install drop box manifolds and sewage distribution pipes in a drainfield at acceptable depths underground, mound type septic systems are utilized. Such systems are provided with an earthen mound above normal ground level which serves as a drainfield into which sewage from a septic tank is direct by a lift pump. Mound systems are also subject to freeze-ups particularly in the pump housing and the pump discharge pipe as the mound systems are not insulated by a substantial amount of earthen material.

There are additional types of underground liquid storage tanks that are susceptible to freeze ups. One such type of underground liquid storage tank is an underground water storage tank commonly used, for example, in Canada and Alaska. In these areas, the rocky earth generally makes drilling wells very difficult and the quality of the ground water is often poor such that alternative water sources are desired. Known underground water storage tanks typically include a tank enclosure interconnected to at least two access pipes accessible from above ground. Underground, a water line interconnects the tank enclosure to the house or other building. Just as with the known septic systems mentioned above, these known water tanks can freeze up in cold winter months resulting in inaccessibility to water and/or water line breakage.

The present invention provides improvements that solve problems with the related art.

### SUMMARY OF THE INVENTION

The present invention relates to heating systems and thermostatic control units for underground tank systems such as septic systems, water tanks and the like that prevents freezing of fluids located within the system. The heater system is used in conjunction with an underground tank system including a tank enclosure and a pipe connecting the tank enclosure to an access point above ground level. The tank enclosure can be a septic tank, water tank or the like. In preferred embodiments, the heater assembly is adapted for fluid flow connection to the access pipe for easy installation and maintenance. The preferred heater system includes a heater assembly having a heating element for producing hot air and a blower assembly positioned and arranged to direct air in heat exchange relation to the heater assembly and to distribute the hot air. The preferred heater assembly further includes a thermostatic control unit for actuating the heating element. In the most preferred embodiments, the thermostatic control unit has a remotely locatable temperature sensor to sense the temperature within a component of the underground tank system, such as the tank enclosure or cleanout/access pipe, by being located within the component of the underground tank system. The temperature sensor is preferably placed proximate where freeze-ups could occur such that the temperature reading is more accurate and can better predict when heating is required.

These and various other advantages and features of novelty which characterize the present invention are pointed out with particularity in the claims annexed hereto and forming a part hereof. However, for a better understanding of the invention, its advantages and objects obtained by its use, reference should be made to the drawings which form a further part hereof, and to the accompanying descriptive matter, in which there is illustrated and described a preferred embodiment of the present invention.

### BRIEF DESCRIPTION OF THE DRAWINGS

In the drawings, in which corresponding reference numerals and letters indicate corresponding parts of the various embodiments throughout the several views, and in which the various embodiments generally differ only in the manner described and/or shown, but otherwise include corresponding parts;

FIG. 1 is schematic view of a septic tank system 10 having a septic tank 16, a plurality of cleanout pipes 22 and a drainfield treatment area 18;

FIG. 2 is a schematic view of a mound septic tank system 10′ having a septic tank 16, a lift station 26, a plurality of cleanout pipes 22 and a mound system treatment area 24;

FIG. 3 is a partial, cutaway view of a septic tank heater 12 of the present invention used in conjunction with the underground tank systems shown and described (only one cleanout pipe 22 is shown for clarity);

FIG. 4 is a partial, cutaway view of the septic tank heater 12 of FIGS. 1-3;

FIG. 5 is an enlarged view of the lift station 26 of FIG. 2; and

FIG. 6 is a schematic view of a water storage tank 54 embodiment.

### DETAILED DESCRIPTION OF THE PREFERRED EMBODIMENT

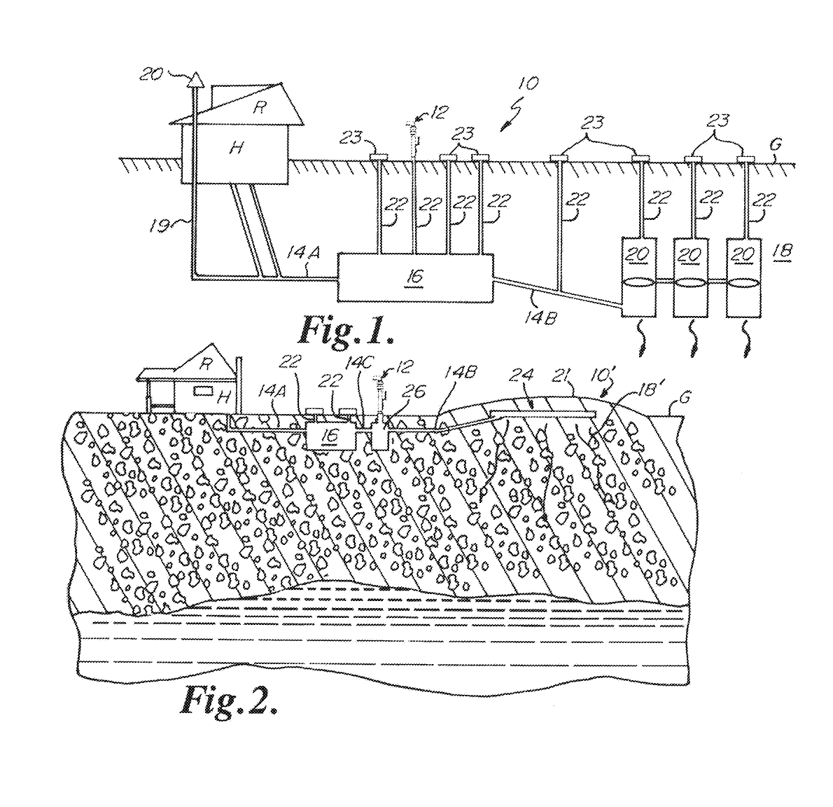

FIG. 1 is a schematic view of a gravity flow septic system 10 incorporating an embodiment of an underground tank heater system 12 of the present invention (the heater system 12 is shown enlarged for clarity). As shown in FIG. 1, the septic system 10 includes a sewer pipe 14A that extends from a house H to a tank enclosure 16 and then on via a sewer pipe 14B to a treatment area 18. In FIG. 1, the treatment area 18 is a drainfield and includes a series of drop boxes 20. As shown, the drop boxes 20 are connected to one another for further distribution of the effluent sewage (not shown). Each drop box 20 typically has a respective cleanout or access pipe 22 to an access port 23 at an above ground level G location. At the house end of the sewer pipe 14A, the sewer pipe 14A is connected by way of a soil stack 19 to a vent 20 that typically protrudes from the roof R of the house H. The septic system 10 further includes additional cleanout pipes 22 that run up to or above ground level G from the septic system 10, for example, from any one or a combination of the septic tank 16, the sewer pipes 14A-B, and the drop boxes 20.

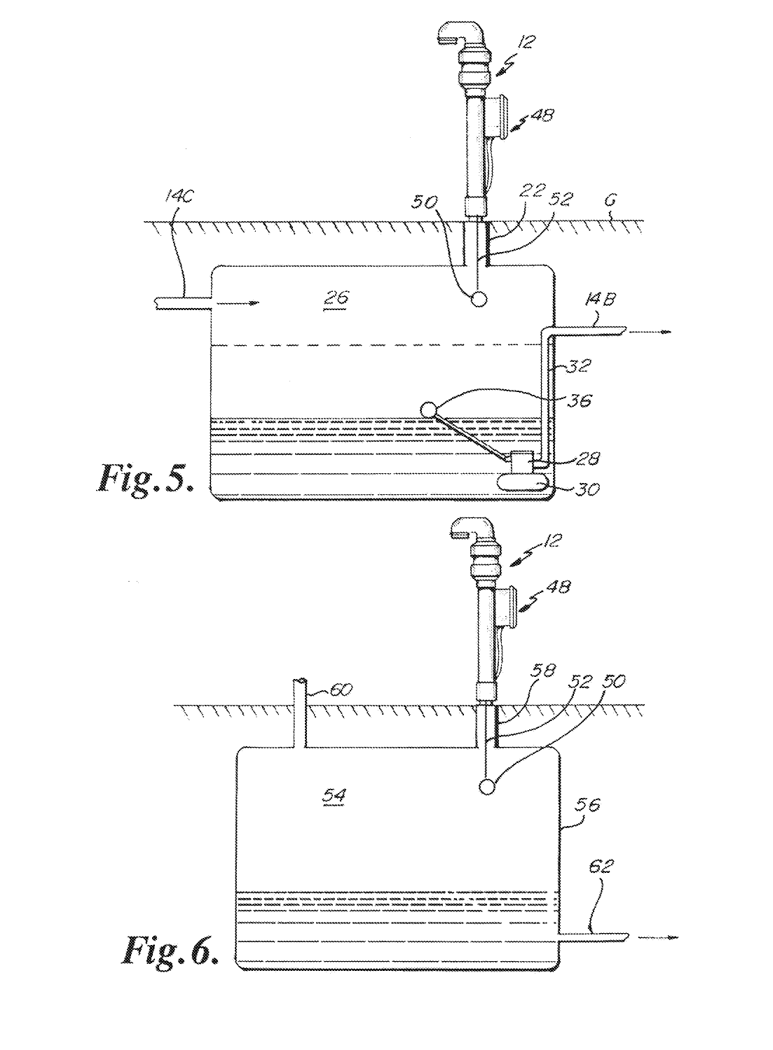

As FIG. 2 illustrates, the present invention can be used in septic systems 10′ of the mound type having a treatment area 18′ within a raised mound system 21. Mound systems are positioned above ground level G and will generally require lift stations 26 to transport the effluent sewage (not shown) against gravitational forces to a sewage distribution header 24 positioned in the mound 21. As shown, the lift station 26 can be aligned in parallel connection with the septic tank 16 with a connection pipe 14C. Alternatively, the lift station 26 can be located within the septic tank 16. Now also referring to FIG. 5, the lift station 26 includes a pump 28 for moving sewage effluent (not shown) upwards towards the mound system treatment area 18′. The preferred lift station 26 includes a pump housing 30 and pipe connections 32 made of PVC or the like. One of the pipe connections 32 extends out from the lift station 26 and is connected to discharge pipe 14B leading to distribution header 24 in the mound 21. In preferred embodiments, pump 28 transfers the sewage effluent (not shown) from the lift station 26, through the pipe 32 and 14B to the mound system for distribution into the treatment area 18′. The preferred pump 28 is submersible and includes a liquid level sensor 36, float switch or the like to activate the pump 28 when the sewage fluid in the lift pump housing 26 reaches a predetermined level.

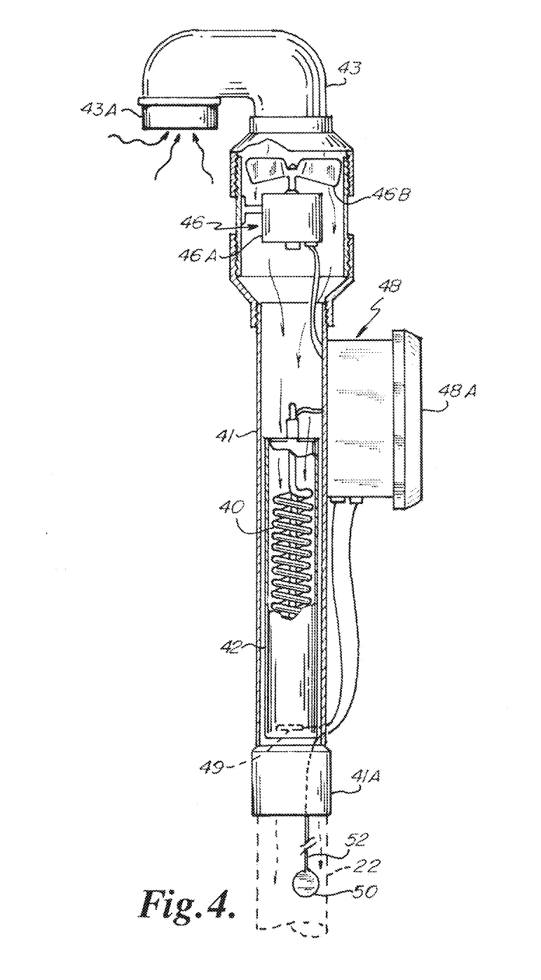

Mound systems are particularly useful in areas where the earth is very rocky and it is difficult to dig deep enough for installing a drainfield. Often, in these areas, the climate is also very cold and the septic systems are prone to freezing in the winter months. To prevent freeze-ups in both ordinary drainfield systems and mound systems, the septic systems 10, 10′ of the present invention preferably include at least one heater system 12. As best illustrated in FIG. 4, the heater system 12 includes a heating element 40, preferably an electric coil, located within a casing 42 that at least partially encloses the heater element 40. An outer housing 41 encloses the heating components, including casing 42, and is arranged and configured at its bottom end 41A to form a coupling defining an output port such that the heater assembly can be mounted in a slip fit over the cleanout pipe 22. The heater system 12 further includes a blower assembly 46 having a motor 46A driving blower 46B located above the heating element 40 within housing 41 for directing and circulating warm or hot air down into the septic system 10, 10′ through the respective access or cleanout pipe 22. For that purpose an air intake pipe 43 is connected to housing 41 above blower 46B and is provided with an air intake 43A.

The heater assembly 12 further includes a thermostatic control unit 48 to activate the electric heater element 40 and blower motor 46A. A removable cover 48A on control unit 48 permits access to the wiring and controls for blower motor 46A and heating element 40. A temperature controller (not shown) is housed within the control unit 48, and may be adjusted to the desired temperature to be maintained within the septic system so as to prevent freeze-ups. The temperature controller preferably includes a sensor 50 that is located within the respective access/cleanout pipe 22, the septic tank 16 or the lift station 26, depending on which component of the septic system 10, 10′ is at risk for freeze-ups. The sensor 50 is preferably attached to a cable or lead wire 52 coupled to the temperature controller and is set to activate the heater system 12 at a predetermined, low temperature that could otherwise cause the septic system 10, 10′ to undergo freeze-up. That temperature is preferably on the order of 38 degrees F. The heater system may be set to operate for an extended time period, e.g., for as long as two hours, after activation, or to shut-off when a predetermined high temperature has been reached. If the heater assembly operates for a long as two hours, the temperature of the air above the liquid in the tank may rise to above 100 degrees F. In preferred embodiments, the position of the sensor 50 within the septic system can be adjusted, for example, by either lengthening or shortening (raising or lowering) the cable 52.

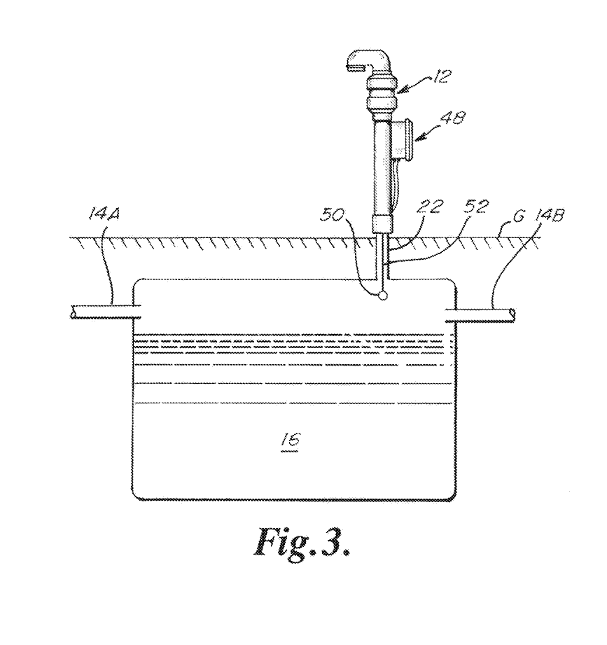

The temperature sensor 50 may be placed within the interior of the septic tank 16 (FIG. 3), inside the lift pump housing 26 (FIG. 5), or within an access pipe 22. In either sensing position, the actual temperature within the septic system is sensed and controlled. Providing a heater and methods that utilize a thermostatic control unit 48 in such a way as to sense and regulate the temperatue inside the septic system provides for a more accurate reading of the temperature of the septic system, which better predicts freezing conditions and more efficiently controls the heater system.

The thermostatic control unit 48 may further include a temperature sensor 49 located near the hot air output end of housing 41 by output coupling 41A. Operation of the heater 40 and blower assembly 46 may be further regulated by the sensor 49 to achieve the desired temperature of warm air discharged through output coupling 41A.

A particular benefit realized by the disclosed heating system is increased bacterial activity in the sewage being handled. Bacteria thrive in a warm environment. Heating the sewage to a temperature above 38 degrees F. greatly enchases bacterial formation and activity. Breakdown of the sewage by bacteria is thus significantly improved.

It will be clear to one of ordinary skill in the art, in light of this disclosure, that the heater system 12 of the present invention will prove useful and effective in many various underground tank systems. Another such underground tank system is illustrated in FIG. 6. FIG. 6 illustrates a water storage tank 54 buried under the ground level G. The water storage tank 54 shown includes a tank enclosure 56 having a fill pipe 58 and a vent pipe 60 leading above the ground level G. The water storage tank 54 further includes a water line or pipe 62 interconnecting the tank enclosure 56 to a house (not shown). The heater assembly 12 of the present invention can be mounted to the fill pipe 58 similarly to how the heater assembly is attached to a cleanout/access pipe as discussed above. The slip fit of heater assembly coupling 41A over fill pipe 58 permits easy mounting and removal of the heater assembly 12. Access to fill pipe 58 to refill tank 54 can thus be readily obtained. The temperature sensor 50 is preferably positioned within the tank enclosure 56 to accurately measure the temperature within the tank enclosure 56. When the heater system 12 is heating the water storage tank 54, heat produced from the heater system 12 flows down through the fill pipe 58, into the tank enclosure 56 and vents through the vent pipe 60. Such heater systems and methods of heating a water tank prevent freeze ups, thus maintaining the water supply and eliminating the associated costs with thawing a freeze-up.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A heater system for an underground tank system located below ground level for containing liquid, the underground tank system including a tank enclosure and a pipe connecting the tank enclosure to above ground level, the heater system comprising:
a heater assembly including a heating element for producing hot air;
a blower assembly positioned and arranged to direct air in heat exchange relation to the heater assembly and to distribute the hot air; wherein the heater assembly is adapted for fluid flow connection to the pipe; and
a thermostatic control unit for actuating the heating element, the thermostatic control unit having a remotely locatable temperature sensor to sense the temperature within a component of the underground tank system by being located within the component of the underground tank system, the component being selected from the group consisting of the tank enclosure and the pipe.

2. The heater system of claim 1, wherein the position of the temperature sensor is adjustable.

3. The heater system of claim 2, wherein the temperature sensor is vertically adjustable, whereby the temperature sensor may be located at a desired elevation within the tank enclosure above the level of the fluid therein.

4. The heater system of claim 1, wherein the heater assembly is adapted to be coupled in a slip-fit connection with the pipe.

5. The heater system of claim 1, wherein the heater assembly includes a housing within which the heating element is contained.

6. The heater system of claim 5, further including a control box mounted on a sidewall of the casing and containing the thermostatic control unit.

7. The heater system of claim 6, wherein the temperature sensor is attached to an extensible lead wire connected to the thermostatic control unit within the control box.

8. The heater system of claim 1, wherein the blower assembly has an air inlet located above the heater assembly.

9. A septic heater system for preventing a septic system from freeze-up wherein the septic system includes a septic tank, connecting sewer pipe, a treatment area, one or more access pipes which rise from one or more portions of the septic system to access ports at or above ground level, the heater assembly having an output port defined by a structure configured for coupling the output port to a selected access pipe access port such that heated air flows from the heating system, through the output port and into the access pipe, the heater system comprising:
a heater assembly including a heating element for producing heated air;
a blower assembly mounted in air flow juxtaposition to the heating element so as to circulate heated air produced from the heating element to the access pipe through the output port; and
a thermostatic control unit in operative association with the heating element such that the thermostatic control unit activates the heating element, wherein the thermostatic control unit has a temperature sensor that is constructed and arranged for selective positioning within a component of the septic system, the component selected from the group consisting of the output port and the portion of the septic system to which the selected access pipe is connected.

10. The septic heater system of claim 9, wherein the position of the temperature sensor is adjustable.

11. The septic heater system of claim 9, wherein the heater assembly is adapted to be mounted in a removable fit on the access pipe.

12. The septic heater system of claim 9, wherein the heater assembly includes a housing enclosing the heating element and blower assembly.

13. A method of heating an underground liquid storage tank to prevent freeze-ups, the method comprising the steps of:
providing a tank containing liquid at an underground location;
providing a heating system having heater assembly and a blower assembly above ground, in proximity to the underground location;
providing a thermostatic control unit having a remotely locatable sensor to sense the temperature within the liquid storage tank;
positioning the sensor to sense the temperature within the tank;
monitoring the temperature within the tank with the thermostatic control unit sensor;
activating the heating system in response to the detection of a predetermined low temperature in the tank by the sensor, such that the heating system produces and circulates heated air; and
directing the heated air into the tank with the blower assembly when the heating system is activated.

14. The method of claim 13, wherein the tank has an access pipe extending above ground and further comprising the step of adjusting the position of the sensor relative to the level of liquid in the tank through the access pipe.

15. The method of claim 14, wherein the temperature sensor is positioned within the access pipe.

16. The method of claim 13, wherein the temperature sensor is positioned within the tank.

17. The method of claim 13, wherein the tank contains drinking water and has a vent opening to the atmosphere, and further comprising the step of venting the heated air within the tank through the vent pipe.

18. The method of claim 13, wherein the liquid comprises sewage in a septic system and further comprising the step of heating the sewage in the tank to a temperature above 38 degrees F., wherein bacterial activity within the sewage is increased with resultant enhanced break down of the sewage.
